(19) United States
(12) Patent Application Publication
(10) Pub. No.: US 2016/0189551 A1
(43) Pub. Date: Jun. 30, 2016

(54) METHOD FOR PROVIDING AN AIRPORT MODEL

(71) Applicant: GE Aviation Systems LLC, Grand Rapids, MI (US)

(72) Inventor: Frazer Leslie Pereira, Cheltenham (GB)

(21) Appl. No.: 14/979,306

(22) Filed: Dec. 22, 2015

(30) Foreign Application Priority Data
Dec. 24, 2014 (GB) 1423173.2

(51) Int. Cl. G08G 5/00; G01C 21/00

(52) U.S. Cl. CPC G08G 5/0047; G01C 21/00

(57) ABSTRACT

A method of providing an airport model from a data server to an aircraft for a flight from a source airport to a destination airport. The method includes prior to take off from the source airport, transmitting from the aircraft a first identifying signal to a first data server associated with the source airport and receiving a complete airport model of a destination airport from the first data server. While in flight and prior to landing at the destination airport, the method further includes transmitting from the aircraft a second identifying signal, including a version indicator for the complete airport model, to a second data server associated with the destination airport and comparing the version indicator to the current version of the airport model and prior to landing.

### BACKGROUND OF THE INVENTION

In contemporary aircraft, numerous airport configuration data may be considered for aiding in aircraft flight planning, landing, taxiing, gating, and take-off. The airport configuration data is often display on the aircraft as an airport model and stored on a flight management computer located on the aircraft. Currently, the airport model is typically updated every twenty eight days and may become stale between flights or during flight.

### BRIEF DESCRIPTION OF THE INVENTION

In one embodiment, the invention relates to a method of providing an airport model from a data server to an aircraft for a flight from a source airport to a destination airport. The method includes prior to take off from the source airport, transmitting from the aircraft a first identifying signal to a first data server associated with the source airport and receiving a complete airport model of a destination airport from the first data server. While in flight and prior to landing at the destination airport, the method further includes transmitting from the aircraft a second identifying signal, including a version indicator for the complete airport model, to a second data server associated with the destination airport, comparing the version indicator to the current version of the airport model and prior to landing and receiving at the aircraft, from the second data server, an update to the complete airport model when the comparison indicates the complete airport model is not the current version.

### BRIEF DESCRIPTION OF THE DRAWINGS

In the drawings:

FIG. 1 is a perspective view of a portion of an aircraft cockpit with a flight display module for showing an airport model.

FIG. 2 is a schematic illustration of the aircraft of FIG. 1 at a source, or take-off, location transmitting and receiving information with the source location according to an embodiment of the invention.

FIG. 3 is a schematic illustration of the aircraft of FIG. 1 approaching a destination, or landing, location transmitting and receiving information with the destination location according to an embodiment of the invention

FIG. 4 is a flow chart illustrating a method for transmitting and receiving data between the aircraft of FIG. 1 and the source and destination location according to another embodiment of the invention.

### DESCRIPTION OF EMBODIMENTS OF THE INVENTION

The exemplary embodiments are described with reference to the drawings. These drawings illustrate certain details of specific embodiments that implement a module, method, or computer program product described herein. However, the drawings should not be construed as imposing any limitations that may be present in the drawings. The method and computer program product may be provided on any machine-readable media for accomplishing their operations. The embodiments may be implemented using an existing computer processor, or by a special purpose computer processor incorporated for this or another purpose, or by a hardwired system.

Embodiments described herein may include a computer program product comprising machine-readable media for carrying or having machine-executable instructions or data structures stored thereon. Such machine-readable media can be any available media, which can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium that can be used to carry or store desired program code in the form of machine-executable instructions or data structures and that can be accessed by a general purpose or special purpose computer or other machine with a processor. When information is transferred or provided over a network or another communication connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data, which cause a general purpose computer, special purpose computer, or special purpose processing machines to perform a certain function or group of functions.

Embodiments will be described in the general context of method steps that may be implemented in one embodiment by a program product including machine-executable instructions, such as program codes, for example, in the form of program modules executed by machines in networked environments. Generally, program modules include routines, programs, objects, components, data structures, etc. that have the technical effect of performing particular tasks or implement particular abstract data types. Machine-executable instructions, associated data structures, and program modules represent examples of program codes for executing steps of the method disclosed herein. The particular sequence of such executable instructions or associated data structures represent examples of corresponding acts for implementing the functions described in such steps.

Embodiments may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the internet and may use a wide variety of different communication protocols. Those skilled in the art will appreciate that such network computing environments will typically encompass many types of computer system configurations, including personal computers, hand-held devices, multiprocessor systems, microprocessor-based or programmable consumer electronics, network PCs, minicomputers, mainframe computers, and the like.

Embodiments may also be practiced in distributed computing environments where tasks are performed by local and remote processing devices that are linked (either by hardwired links, wireless links, or by a combination of hardwired or wireless links) through a communication network. In a distributed computing environment, program modules may be located in both local and remote memory storage devices.

An exemplary system for implementing the overall or portions of the exemplary embodiments might include a general purpose computing device in the form of a computer, including a processing unit, a system memory, and a system bus, that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD-ROM or other optical media. The drives and their associated machine-readable media provide nonvolatile storage of machine-executable instructions, data structures, program modules and other data for the computer.

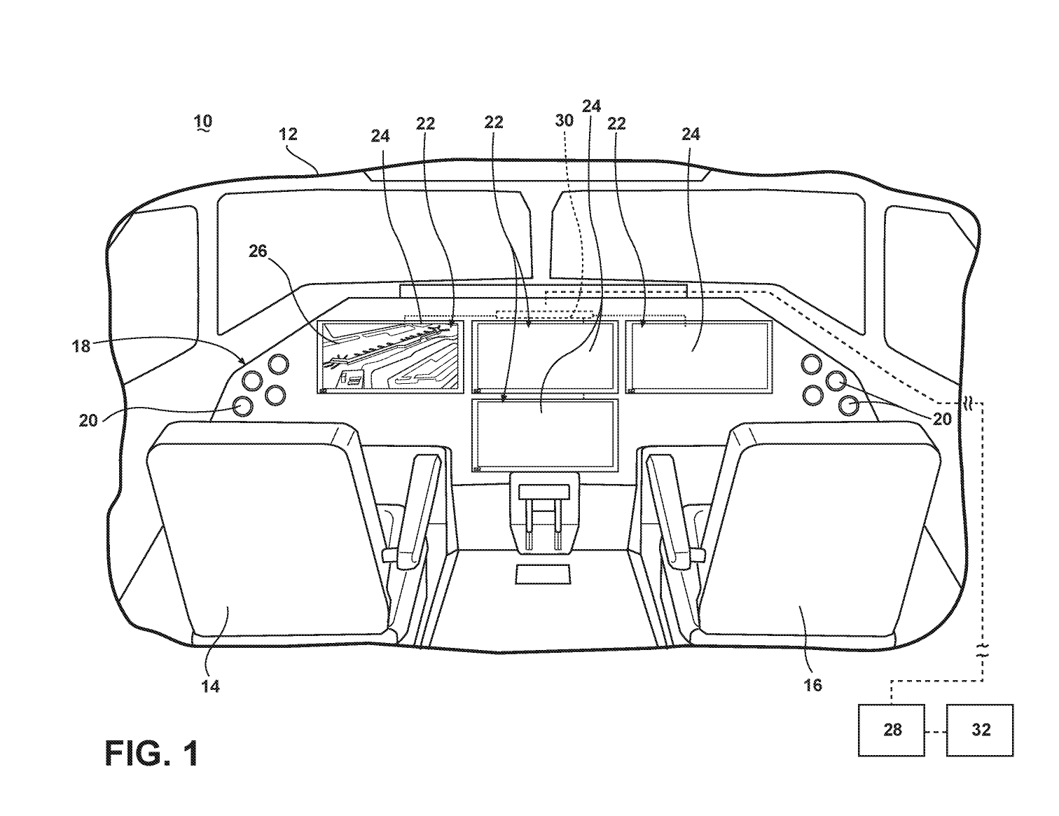

FIG. 1 illustrates a portion of an aircraft 10 having a cockpit 12. While a commercial aircraft has been illustrated, it is contemplated that embodiments of the invention may be used in any type of aircraft, for example, without limitation, fixed-wing, rotating-wing, rocket, personal aircraft, and military aircraft, or for that matter, any application where the aircraft uses visual aids in aircraft flight planning, landing, taxiing, gating, and take-off. In this embodiment, a first user (e.g., a pilot) may be present in a seat 14 at the left side of the cockpit 12 and another user (e.g., a co-pilot) may be present at the right side of the cockpit 12 in a seat 16. A flight deck 18 having various instruments 20 and multiple flight display modules 22 may be located in front of the pilot and co-pilot and may provide the flight crew with information to aid in taxiing and flying the aircraft 10.

The flight display modules 22 may include either primary flight displays or multi-function displays and may display a wide range of aircraft, flight, navigation, systems, and other information used in the operation and control of the aircraft 10. The flight display modules 22 have been illustrated as being in a spaced, side-by-side arrangement with each other. The flight display modules 22 may be laid out in any manner including having fewer or more displays. The flight display modules 22 may also be located in a pilot's or co-pilots helmet display or as a heads up display (HUD). Further, the flight display modules 22 need not be coplanar and need not be the same size. A display panel 24 on which the display representation may be provided may be included in the flight display modules 22. This display panel may include any display panel having a matrix of individually controllable pixels, such as LCD and LED. By way of non-limiting example the display panel 24 may be a flat Active Matrix Liquid Crystal Display (AMLCD) panel.

A cockpit display unit 30 may be operably coupled to components of the aircraft 10 including the flight display modules 22. The cockpit display unit 30 may also be connected with other controllers (not shown) of the aircraft 10 and may include memory and processing units, which may be running any suitable programs to display information to the aircraft's pilots. The cockpit display unit 30 may include one or more graphic processors dedicated to rendering high resolution displays. The cockpit display unit 30 may also receive inputs from one or more other additional sensors (not shown), which may provide the cockpit display unit 30 with various information to aid in the operation of the aircraft 10.

Modern aircraft use a time-shared Ethernet data channel between a flight management computer 28 and the cockpit display unit 30 which together, define a flight management system (FMS). The flight light management computer 28 is a multi-processor cabinet with general purpose processors that host a number of application programs, one of which may be an airport model system application. As depicted in FIG. 1, at least one of the display modules 22 may be configured as a navigation display (ND) and may display data such as an airport model 26 used to aid in the aircraft 10 flight planning, landing, taxiing, gating and takeoff. The airport model 26 may contain and display information including geographic features in 2D or 3D such as an airport surface map displaying traffic (in air or on ground), runways, runway centerlines, runway labels, taxiways, taxiway centerlines, taxiway labels, hold short lines, non-movement areas, grassy areas, buildings, fence lines, neighboring areas, obstacles and stand areas. The airport model 26 may also contain and display information in 2D or 3D including airport conditions such as weather conditions, airport construction, airport electrical conditions, airport threat levels, and taxiway or gate closures. It will be understood that the airport model 26 may contain and display any other information pertinent to aircraft 10 flight planning, landing, taxiing, gating or take off and may be a model for an airport, an aircraft carrier or any other location where an aircraft may land or take-off. Information used to generate the airport model 26 is stored on the flight management computer 28 and more specifically, on a database operably coupled to the flight management computer 28.

A wireless communication link 32 may be communicably coupled to the flight management computer 28 or other processors of the aircraft to transfer and receive data to and from the flight management computer 28. Such a wireless communication link 32 may be any one or multiples of a variety of communication mechanism capable of wirelessly linking with other systems and devices and may include, but is not limited to, packet radio, satellite uplink, Wireless Fidelity (WiFi), WiMax, Bluetooth, ZigBee, 3G wireless signal, code division multiple access (CDMA) wireless signal, global system for mobile communication (GSM), 4G wireless signal, long term evolution (LTE) signal, Ethernet, or any combinations thereof. It will also be understood that the particular type or mode of wireless communication is not critical to embodiments of the present invention, and later-developed wireless networks are certainly contemplated as within the scope of embodiments of the present invention. Further, the wireless communication link 32 may be communicably coupled with the flight management computer 28 through a wired link without changing the scope of embodiments of the present invention. Although only one wireless communication link 32 has been illustrated it is contemplated that the aircraft 10 may have multiple wireless communication links communicably coupled with the flight management computer 28 or other onboard computing device. Such multiple wireless communication links may provide the aircraft 10 with the ability to transfer and receive data in a variety of ways such as by satellite, GSM, and WiFi.

During operation, the flight management computer 28 may transmit or receive data related to the airport model 26 via the wireless communication link 32 from an external source. The flight management computer 28 may execute a program for transmitting or receiving the data from the external source, which may be similarly equipped with a wireless communication link 32. Alternatively, a separate module or computer may execute a program for transmitting or receiving airport model data from the external source. The process may be implemented automatically by the flight management computer 28 or the separate module or computer.

For example, the flight management computer 28 may run a program for transmitting or receiving airport model data. The program may include a computer program product that may include machine-readable media for carrying or having machine-executable instructions or data structures stored thereon. Such machine-readable media may be any available media, which can be accessed by a general purpose or special purpose computer or other machine with a processor. Embodiments of the invention will be described in the general context of a method that may be implemented in one embodiment by a program product including machine-executable instructions, such as program code, for example, in the form of program modules. Generally, program modules include routines, programs, objects, components, data structures, algorithms, etc., that have the technical effect of performing particular tasks or implement particular abstract data types. Machine-executable instructions, associated data structures, and program modules represent examples of program code for executing the method disclosed herein. Machine-executable instructions may include, for example, instructions and data, which cause a general purpose computer, special purpose computer, or special purpose processing machine to perform a certain function or group of functions.

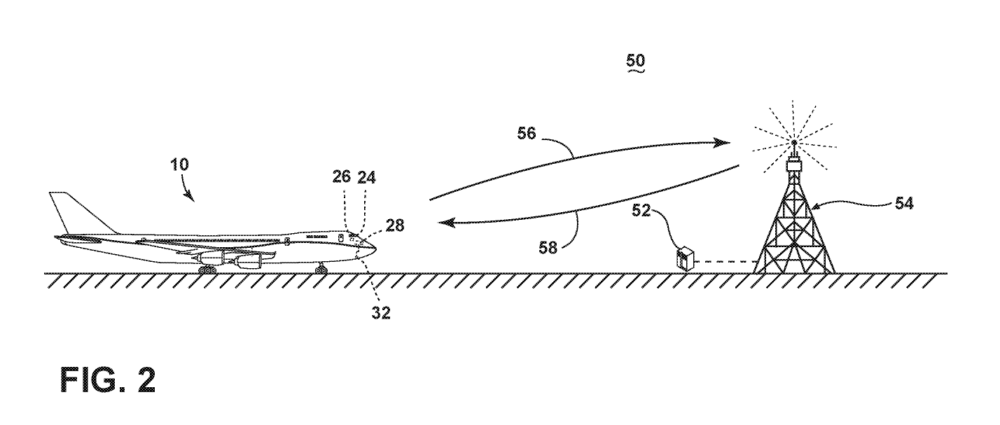

FIG. 2 depicts the aircraft 10 at a first or source location 50 prior to a flight to a second or destination location. At the source location 50, the flight management computer 28 contains the information used to generate the airport model 26 for the source location which is displayed on one of the display panels 24 to aid in aircraft gating, taxiing and takeoff from the source location 50. Prior to takeoff, the flight management computer 28 sends an first identifying signal 56 to a computer or source location data server 52 which may be located at and associated with a source designated ground system 54 at the source location 50 via the wireless communication link 32. The source designated ground system 54 may also be equipped with a similar wireless communication link 32 and may be any type of communicating ground system 54 such as an airline operations center.

The first identifying signal 56 contains information relating to the flight management computer 28, allowing the source location data server 52 to determine the planned destination location of the aircraft 10. The source location data server 52 may determine if the flight management computer 28 of the aircraft 10 contains the destination model airport information 58 and whether the destination model airport information 58 is a current version. This may be achieved by including a version indicator of the destination model airport information 58 on the flight management computer 28 in the first identifying signal 56. For example, the version indicator may be a date stamp for the destination airport model information 58 contained on the flight management computer 28.

If the flight management computer 28 does not contain the destination model airport information 58 or contains an old version of the destination model airport information 58, the aircraft 10 then receives destination airport model information 58 from the source location data server 52 via the wireless communication link 32 and uploads the destination airport model information 58 to the flight management computer 28. If the flight management computer 28 does current version of the destination model information 58, no further action is needed on the part of the source location data server 52. The first identifying signal 56 may also contain information allowing the source location data server 52 to determine the make and model of the aircraft 10 so that the destination airport model information 58 is in a format that corresponds to the make and model of the aircraft 10 and can be received by the flight management computer 28.

The destination model airport information 58 will be used to generate and display the complete airport model 26 of the destination location prior to the aircraft 10 arriving at the destination location. The wireless communication link 32 may have limited bandwidth available for transmitting or receiving extensive data from the source designated ground system 54, and, in any event, it may be costly to communicate large amounts of data via the wireless communication link 24 to the source designated ground system 54. Thus, it is contemplated that the flight management computer 28 may be hardwired to the source location data server 52 to transmit the first identifying signal 56 and receive the destination airport model information 58 via the hardwired connection. Any previous airport models stored on the flight management computer 28 may be erased prior to takeoff such that the flight management computer 28 only contains the source airport model and destination airport model at a given time.

The process of transmitting the first identifying signal 56 and receiving the destination airport model information 58 may be implemented automatically by the flight management computer 28. Alternatively this process may be implemented manually by crew members on the aircraft 10 or at the source location 50.

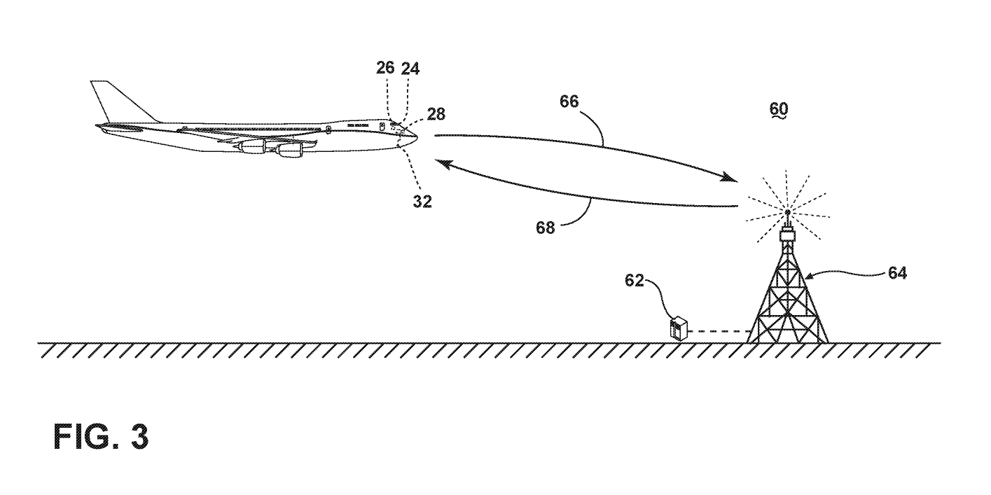

FIG. 3 shows the aircraft 10 in flight after departing the source location and in route to a destination location 60. Prior to landing at the destination location 60, most likely during one of a cruise or a decent phase of the flight, the flight management computer 28 sends a second identifying signal 66 to a computer or destination location server 62 which may be located at and associated with a destination designated ground system 64 at the destination location 60 via the wireless communication link 32. The destination designated ground system 64 may also be equipped with a similar wireless communication link 32 and may be any type of communicating ground system such as an airline operations center.

The second identifying signal 66 contains information relating to the flight management computer 28, allowing the destination location data server 62 to determine if the flight management computer 28 of the aircraft 10 contains the destination model airport information and whether the destination model airport information is a current version. This may be achieved by including a version indicator of the destination model airport information on the flight management computer 28 in the second identifying signal 66. For example, the version indicator may be a date stamp for the destination airport model information contained on the flight management computer 28.

If the flight management computer 28 does not contain the destination model airport information or contains an old version of the destination model airport information, the aircraft 10 then receives destination airport model update 68 from the destination location data server 62 via the wireless communication link 32 and uploads the destination airport model update 58 to the flight management computer 28. If the flight management computer 28 does current version of the destination model information, no further action is needed on the part of the destination location data server 62. The second identifying signal 66 may also contain information allowing the destination location data server 62 to determine the make and model of the aircraft 10 so that the destination airport model update 68 is in a format that corresponds to the make and model of the aircraft 10 and can be received by the flight management computer 28. It will be understood that the first and second identifying signals 56, 66 may contain the same information.

The second identifying signal 66 may be transmitted when the aircraft 10 is within a predetermined range or radius from the destination location 60. Similarly, the destination airport model update 68 may be received when the aircraft 10 is also with the predetermined range or radius from the destination location 60. The flight management computer 28 may continually determine or periodically determine at preset intervals whether the aircraft 10 is within the predetermined range from the destination location 60. Alternatively, the second identifying signal 66 may be transmitted and the destination airport model update 68 may be received when the aircraft 10 changes a predetermined flight phase. For example, the second identifying signal 66 may be transmitted and the destination airport model update 68 may be received when the aircraft 10 begins the decent phase of the flight.

The initiation and execution of transmitting the second identifying signal 66 and receiving the destination airport model update 68 may be implemented automatically by the flight management computer 28 using a computer program. Alternatively this process may be implemented manually by crew members on the aircraft 10 or destination location 60.

The destination airport model update 68 contains information that has changed during flight of the aircraft 10 or after the destination airport model information was received by the flight management computer 28 at the source location prior to take-off. If no information has changed, the aircraft 10 may not receive the destination airport model update 68. The destination airport model update 68 may include but is not limited to updated information related to traffic (in air or on ground), runways, runway centerlines, runway labels, taxiways, taxiway centerlines, taxiway labels, hold short lines, non-movement areas, grassy areas, buildings, fence lines, neighboring areas, obstacles and stand areas, weather conditions, airport construction, airport electrical conditions, airport threat levels, and taxiway or gate closures. It will be understood that the destination airport model update 68 contains less data or information and requires less bandwidth to wirelessly receive compared to the destination airport model information received at the source location.

The flight management computer 28 uses both the destination airport model information and the destination airport model update 68 to generate and display the airport model 26 on one of the display panels 24. In this way the airport model 26 contains the most up-to-date information related to the destination location 60 to better aid the aircraft 10 in flight planning, landing, taxiing, gating and a subsequent take-off. The airport model 26 may also be displayed on one of the display panels 24 prior to receiving the destination airport model update 68 and then the updated airport model 26 may be displayed on one of the display panels 24 after the destination airport model update 68 is uploaded to the flight management computer 28.

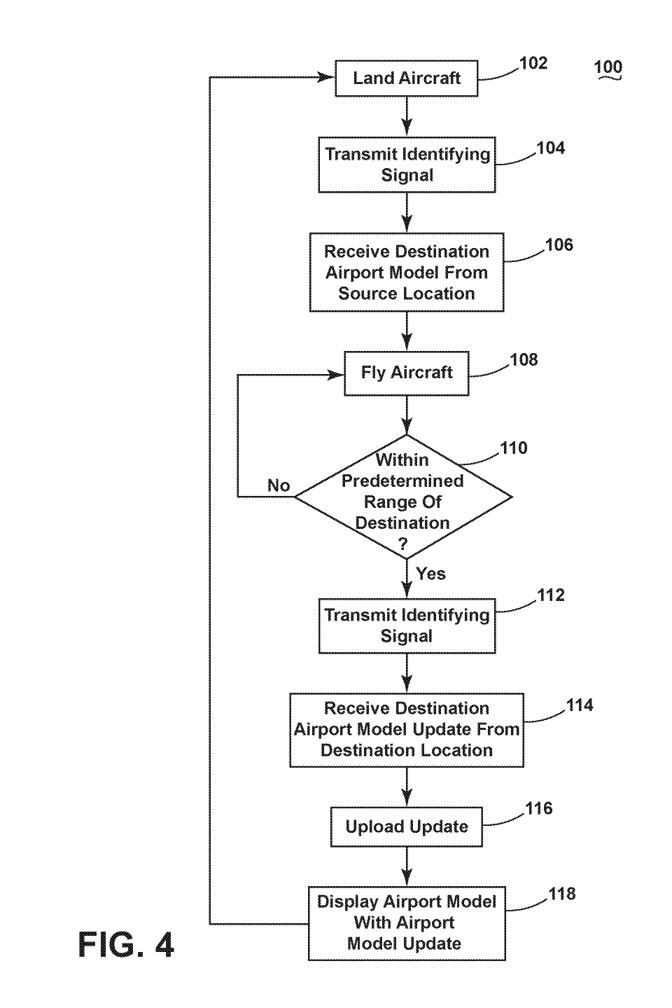

Embodiments of the invention include the aircraft receiving destination airport model information at a source location prior to take off and receiving a destination airport model update during flight and prior to landing at the destination location. In accordance with an embodiment of the invention, FIG. 4 illustrates a method 100, which may be used for receiving the airport model information and the airport model update. The method 100 includes landing the aircraft at 102, transmitting an identifying signal at 104, optionally receiving a destination airport model at 106, flying the aircraft at 108, determining whether the aircraft is within predetermined range of the destination location at 110, transmitting a identifying signal at 112, optionally receiving a destination airport model update at 114, uploading the update at 116 and displaying the updated destination airport model at 118.

The method 100 begins at 102 with landing the aircraft. Once landed, the aircraft is considered to be at the source location wherein the next planned destination of the aircraft is considered to be the destination location. While grounded at the source location, the aircraft sends the first identifying signal to the source location at 104. The aircraft conditionally receives the destination airport model from the source location at 106 based on the identifying signal. The aircraft may erase any previous airport models from previous locations from the flight management computer before or after the destination airport model is optionally received.

The aircraft then flies to the destination location along a flight path at 108. The aircraft may determine if/when the aircraft is within a predetermined range of the destination location at 110. This may occur continuously, at preset time intervals, at predetermined locations, or at any other suitable manner. When the aircraft is within the predetermined range of the destination location, the aircraft transmits the second identifying signal at 112. The aircraft conditionally receives the destination airport model update from the destination location at 114 based on the identifying signal. The destination airport model update is uploaded to the aircraft at 116 and the airport model with the update is displayed in the aircraft at 118. The crew of the aircraft uses the displayed destination airport model with the destination airport model update to land, taxi, gate, and for subsequent takeoffs at the destination location. The method 100 is then repeated starting at 102. It will be understood that after landing at the destination location and prior to a subsequent take-off, the aircraft is considered to be at the source location.

Technical effects of the above described embodiments include that the destination airport model displayed on the aircraft is updated with up-to-date information during flight and before landing at the destination location. Currently information related to airport models is updated only every twenty eight days and there is no mechanism in place by which the airport model may be updated in flight to represent any changes at the destination location. The above described embodiments use a destination airport model received and uploaded at the source location and destination airport model update received and uploaded during flight to generate an airport model representative of the current features and conditions at the destination location. The above described embodiments may result in many benefits including low bandwidth requirements when sending airport model updates prior to landing, less memory needed to store airport models because only a source and a destination airport model may be stored at any given time, reduction in the chance of having outdated airport information and improved take-off, flight planning, landing, taxiing and gating as the pilot has the most recent information to make decisions upon.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of providing an airport model from a data server to an aircraft for a flight from a source airport to a destination airport, the method comprising:
prior to take off from the source airport, transmitting from the aircraft a first identifying signal to a first data server associated with the source airport;
receiving a complete airport model of a destination airport from the first data server;
while in flight and prior to landing at the destination airport, transmitting from the aircraft a second identifying signal, including a version indicator for the complete airport model, to a second data server associated with the destination airport;
comparing the version indicator to the current version of the airport model; and
prior to landing, receiving at the aircraft, from the second data server, an update to the complete airport model when the comparison indicates the complete airport model is not the current version.

2. The method of claim 1 wherein the second identifying signal is sent during one of a cruise phase or descent phase of the flight.

3. The method of claim 2 wherein the receiving of the update occurs during one of the cruise phase or descent phase.

4. The method of claim 3 wherein the receiving the update occurs during the descent phase.

5. The method of claim 1 wherein the transmitting the first identifying signal, receiving complete airport model, transmitting the second identifying signal, comparing the version indicator to the current version of the airport model and receiving the update occur automatically.

6. The method of claim 1 wherein the transmitting of the second identifying signal is done wirelessly.

7. The method of claim 1 wherein the airport model contains information related to at least one of traffic, runways, runway centerlines, runway labels, taxiways, taxiway centerlines, taxiway labels, hold short lines, non-movement areas, grassy areas, buildings, fence lines, neighboring areas, obstacles and stand areas, weather conditions, airport construction, airport electrical conditions, airport threat levels, taxiway closures or gate closures.

8. The method of claim 7 wherein the airport model update contains information related to the airport model that has changed during the flight from the source airport to the destination airport.

9. The method of claim 8 wherein the airport model update contains less information than the airport model.

10. The method of claim 1 wherein at least one of the first or second identifying signals contains information including the aircraft make and model.

11. The method of claim 10 wherein at least one of the airport model and update is specific to the aircraft make and model.

12. The method of claim 1 wherein the second identifying signal includes data indicative of a version identifier for the airport model.

13. The method of claim 12 wherein the version identifier is a date stamp for the airport model.

14. The method of claim 1 wherein the first and second identifying signals contain the same information.

15. The method of claim 1 wherein the first and second data servers are the same data server.
